(19) United States
(12) Patent Application Publication
(10) Pub. No.: US 2002/0143988 A1
(43) Pub. Date: Oct. 3, 2002

(54) System and method to implement an improved frame fragmentation protocol to facilitate efficient transmission of prioritized data

(76) Inventor: Bent S. Jensen, Frederiksberg C. (DK)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/823,127

(22) Filed: Mar. 30, 2001

(51) Int. Cl. G06F 15/173

(52) U.S. Cl. 709/240

(57) ABSTRACT

The present invention relates to a system and method to implement an improved frame fragmentation protocol to facilitate efficient transmission of prioritized data. The system includes a sending unit transmitting a first frame fragment, the first frame fragment including a first data segment extracted from a low priority frame and a first frame fragmentation control information appended to the end of the first data segment. The system further includes a receiving unit receiving the first frame fragment transmitted by the sending unit.

### BACKGROUND

(1) Field

The present invention relates to a system and method to implement an improved frame fragmentation protocol to facilitate efficient transmission of prioritized data.

(2) General Background

Currently, there are a number of techniques to process data streams in which high priority data and low priority data are mixed. Examples of these techniques include Quality of Service Point-to-Point Protocol (QoSPPP) and a processing technique proposed in Request for Comments 2687 (RFC 2687), “PPP in a Real-time Oriented HDLC-like Framing”, published in September 1999.

The aim of QoSPPP is to allow a transmitting unit to run a mix of applications with varying communications needs. Currently most Point-to-Point Protocol (PPP) implementations offer a single class of service, best-effort, which is most suited for conventional data applications (e.g., Telnet, ftp, email, etc.). However, newer Internet applications such as packet telephony, video conferencing, etc., require a new class of service with bandwidth guarantees and upper bounds of the delay and jitter seen by their packets. QoSPPP supports four classes of service, namely Available Bit Rate (ABR), Unspecified Bit Rate (UBR), Constant Bit Rate (CBR), and Variable Bit Rate (VBR).

ABR supports traditional data applications, which do not need bandwidth guarantees or any strict bounds on delays and jitters. These data applications typically have variable sized packets. However, ABR applications will specify their maximum datagram size, expected bandwidth usage, and maximum tolerable delays. The class of service is specified the flowspec along with other parameters like bandwidth, delay, and jitter. While the network does not guarantee delays and jitters, it uses them to estimate buffer sizes and expected load. UBR or Unspecified Bit Rate is for legacy applications that are not aware of the Quality of Service (QoS).

CBR or Constant Bit Rate is for applications that transmit data at regular intervals. Datagrams are usually small and has fixed length (though the latter is not a requirement). An example is a packet phone that does not perform silence detection. Datagrams have strict upper bounds on delay and jitter that can be tolerated and also on bandwidth requirements. VBR or Variable Bit Rate is similar to CBR, except that the rate of packet transmission is not fixed.

RFC 2687 generally proposes suspend/resume mechanism and also multiple classes to obtain multiple levels of suspension. However, the applicability of the multilink header for a suspend/resume mechanism is limited, as the “end” bit is in the multilink header, which is the wrong location for suspend/resume operation. To suspend a big packet, the packet must be sent with the “end” bit off, and (unless the packet was suspended a small number of bytes before its end) and an empty fragment has to be sent afterwards to “close” the packet. The minimum overhead for suspending a packet thus is twice the multilink header size (six bytes, including a compressed multilink protocol field) plus one PPP framing (three bytes). Each suspension costs another six bytes (not counting the overhead of the framing for the intervening packet).

### BRIEF DESCRIPTION OF THE DRAWINGS

FIG. 1 is an exemplary diagram of a system in accordance with one embodiment of the present invention;

FIG. 2 is an exemplary block diagram of a sending unit and a receiving unit in accordance with one embodiment of the present invention;

FIGS. 3 and 3A illustrate the format of an exemplary frame fragment in accordance with one embodiment of the present invention;

FIG. 4 shows an example of frame fragments generated from a given frame in accordance with one embodiment of the present invention;

FIG. 5 illustrates an example where transmission of frames having high priority data is promoted over frames having low priority data in accordance with one embodiment of the present invention;

FIG. 6 illustrates an exemplary order in which the receiving unit assembles frames after receiving frame fragments in accordance with one embodiment of the present invention;

FIG. 7 generally outlines an exemplary process of promoting the transmission of high priority frames over the transmission of low priority frames using the frame fragmentation technique in accordance with one embodiment of the present invention; and

FIG. 8 generally outlines an exemplary process of generating frame fragmentation control information in accordance with one embodiment of the present invention.

### DETAILED DESCRIPTION

The present invention relates to a system and method to implement an improved frame fragmentation protocol to facilitate efficient transmission of prioritized data.

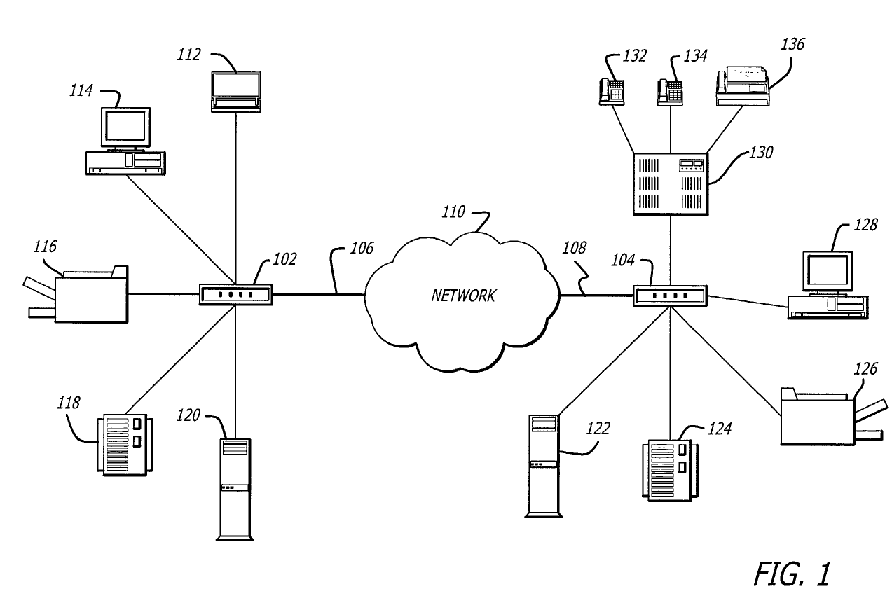

FIG. 1 is an exemplary diagram of a system 100 in accordance with one embodiment of the present invention. The system 100 includes network switches or routers 102, 104 that are operatively coupled together by network links 106,108 and network 110.

Network switch or router 102 is coupled to a plurality of network devices 112, 114, 116, 118, 120. Network devices are generally computing devices having networking capability. As illustrated in FIG. 1, examples of network devices can include a laptop computer 112, a desktop computer 114, a network printer 116, a network storage device 118, and a server 120. In practice, a network device can be a set-top-box, a hand-held device, or any computing devices with networking capability.

Network switch or router 104 is coupled to a plurality of network devices, including a server 122, a network storage device 124, a network printer 126, and a desktop 128. Network switch or router is also coupled to a private branch exchange (PBX) system 130. PBX system 130 is coupled to telephones 132,134 and fax machine 136.

Each device in the system 100 can be a sending unit, a receiving unit, or both. A sending unit is generally a device that transmits data to a receiving unit. A receiving unit is generally a device that receives data transmitted by the sending unit.

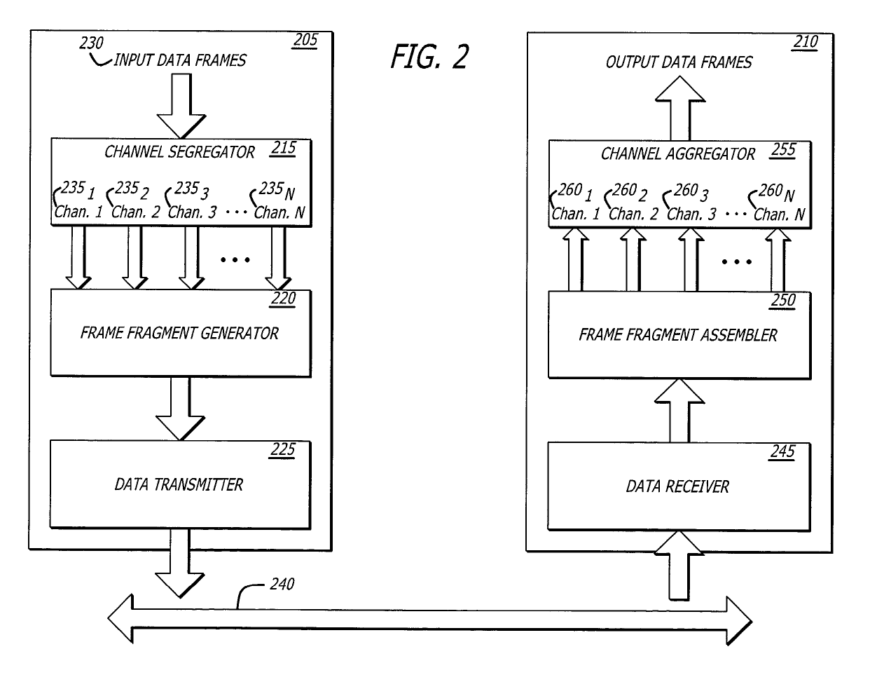

FIG. 2 is an exemplary block diagram of a sending unit 205 and a receiving unit 210 in accordance with one embodiment of the present invention. Sending unit 205 can include a channel segregator 215, a frame fragment generator 220, and a data transmitter 225. Channel segregator 215 receives input data frames 230, which can come from sources internal or external to the sending unit 205 and which is designated for a logical communication channel 235₁, 2352₂, . . . , 235_{N} where “N” is a positive integer. Channel segregator 215 generally places input data frames 230 on the designated logical communication channel 235₁, 235₂, . . . , 235_{N} to forward the input data frames 230 to the frame fragment generator 220.

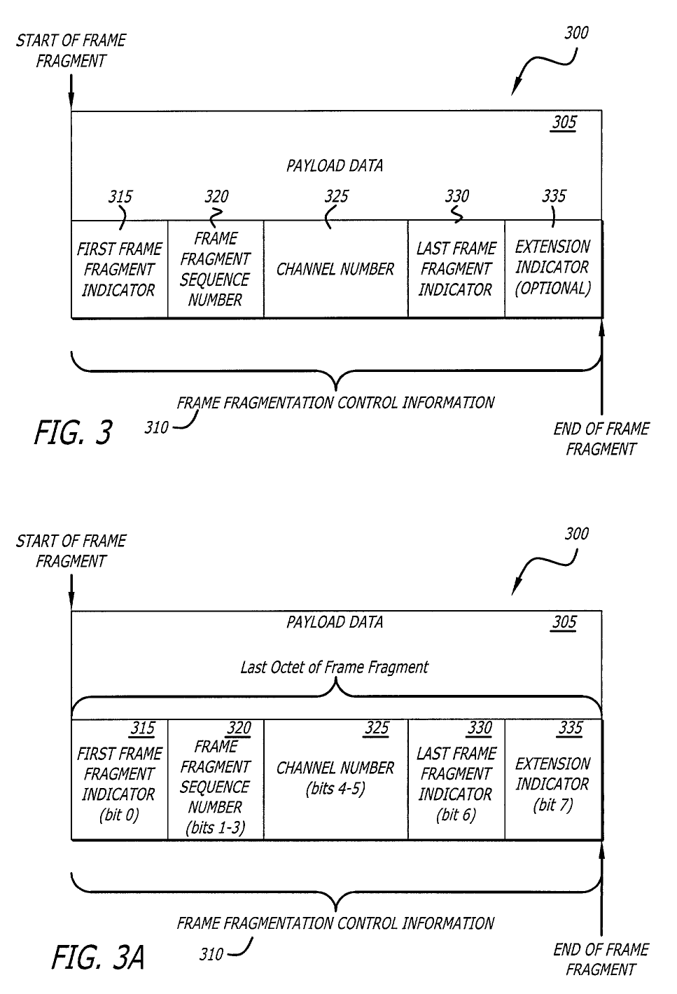

Frame fragment generator 220 receives and processes input data frames 230 forwarded by channel segregator 215. When necessary, frame fragment generator 220 breaks the input data frames 230 into data segments, generates frame fragments to encapsulate these data segments, and forwards these frame fragments to data transmitter 225. Data transmitter 225 sends the frame fragments to receiving unit 210 via communication link 240. Additional details about the format of frame fragments will be provided below in FIG. 3 and the description of the figure.

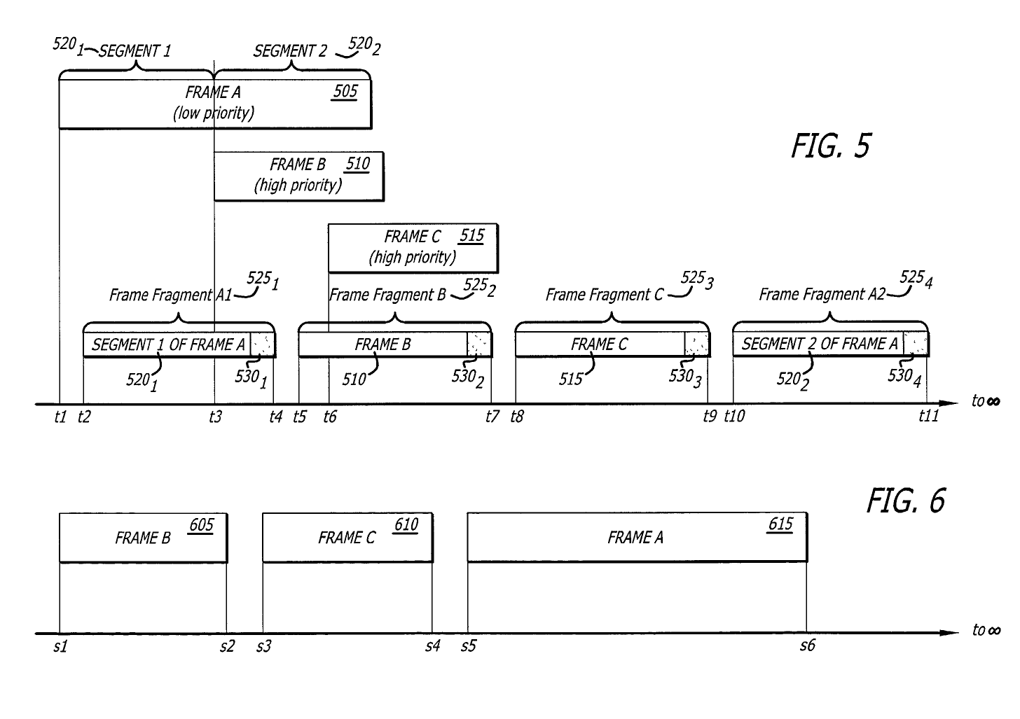

In general, sending unit 205 generates frame fragments to promote transmission of frames having high priority data over frames having low priority data. An example, where the sending unit generates frame fragments to promote transmission of higher priority frames over low priority data, will be provided below in FIGS. 5 and 6 and the text describing these figures.

Receiving unit 210 can include a data receiver 245, a frame fragment assembler 250, and a channel aggregator 255. Data receiver 245 extracts frame fragments from communication link 240 and forwards the frame fragments to frame fragment assembler 250. Frame fragment assembler 250 combines the frame fragments into frames and forwards the frames to channel aggregator 255 through a designated logical communication channel 260₁, 260₂, . . . , 260_{N}. Channel aggregator 255 extracts data frames from logical communication channels and forwards or outputs the data frames to destinations internal or external to the receiving unit 210.

It should also be noted that the functional components, as shown in FIG. 2 and described in the text accompanying the figure, could be implemented in hardware. However, these functional components can also be implemented using software code segments. Each of the code segments may include one or more programming instructions. If the aforementioned functional components are implemented using software code segments, these code segments can be stored on a machine-readable medium, such as floppy disk, hard drive, CD-ROM, DVD, tape, memory, or any storage device that is accessible by a computing machine.

FIG. 3 illustrates the format of an exemplary frame fragment 300 in accordance with one embodiment of the present invention. The exemplary frame fragment 300 can include payload data 305 and frame fragmentation control information 310. Payload data 305 is generally a data segment extracted from a data frame. Frame fragmentation control information 310 generally includes information that can be used to assemble frame fragments 300 into frames.

As shown in the figure, frame fragmentation control information 310 is located at the end of a frame fragment 300. The strategic placement of frame fragmentation control information 310 at the end of a frame fragment 300 provides certain advantages in promoting the transmission of high priority frames over the transmission of low priority frames, as will be shown below in FIG. 5 and the description of the figure.

In one embodiment, frame fragmentation control information 310 can include the following fields: first frame fragment indicator (FFFI) 315, frame fragment sequence number (FFSN) 320, channel number (CN) 325, and last frame fragment indicator (LFFI) 330. First frame fragment indicator 315 specifies whether a frame fragment is a first fragment generated from a frame. Frame fragment sequence number 320 specifies a sequential order number assigned to each frame fragment generated from a frame. Channel number 325 indicates the logical communication channel to which the frame fragment is designated. Channel number 325 is generally used to differentiate multiple payload data flows. Last frame fragment indicator 330 specifies whether a frame fragment is a last fragment generated from a frame.

Frame fragment control information 310 can also include an optional extension indicator 335. The extension indicator 335 is generally used to extend or add fields to the frame fragment control information 310. If the frame fragmentation control information 310 only includes EI 335, FFFI 315, FFSN 320, CN 325, and LFFI 330, extension indicator 335 would be set to FALSE. On the other hand, if frame fragmentation control information includes field or fields in addition to EI 335, FFFI 315, FFSN 320, CN 325, and LFFI 330, extension indicator 335 would be set to TRUE. In one embodiment, FALSE can be represented by a value of one (1), and TRUE can be represented by a value of zero (0).

FIG. 3A shows one exemplary implementation of the frame fragment shown in FIG. 3 in accordance with one embodiment of the present invention. In this implementation, frame fragment control information 310 occupies the last octet of the frame fragment 300. In the last octet of the frame fragment, FFFI 315 is a one-bit field and occupies the first bit of the octet; FFSN 320 is a three-bit field and occupies the second, third, and fourth bits of the octet; CN 325 is a two-bit field and occupies the fifth and sixth bits of the octet; LFFI 330 is a one-bit field and occupies the seventh bit of the octet; and EI 335 is a one-bit field and occupies the eighth or last bit of the octet.

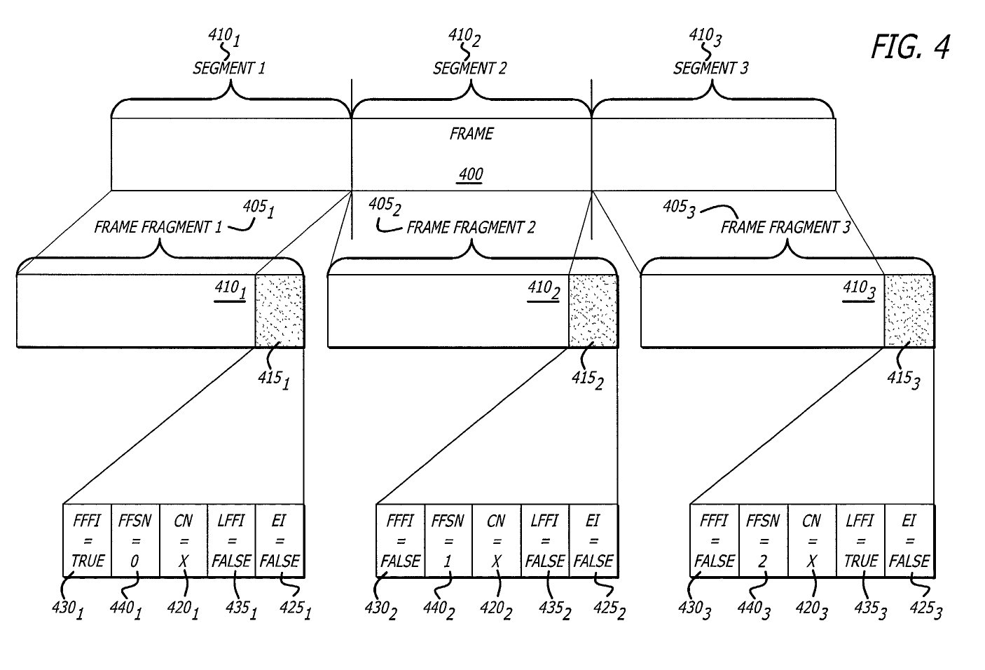

FIG. 4 shows an example of frame fragments 405₁, 405₂, 405₃ generated from a given frame 400 in accordance with one embodiment of the present invention. In the example, the given frame 400 is designated for logical communication channel X, where X is a positive integer. As shown in the figure, the frame is broken up into three data segments 410₁, 410₂, 410₃. Three frame fragments 405₁, 405₂, 405₃ are generated to encapsulate the three data segments 410₁, 410₂, 410₃. The first frame fragment 405₁ includes the first data segment 410₁ of the frame 400, the second frame fragment 405₂ includes the second data segment 410₂ of the frame 400, and the third frame fragment 405₃ includes the third data segment 410₃ of the frame 400.

Each frame fragment 405₁, 405₂, 405₃ includes a frame fragmentation control information 415₁, 415₂, 415₃. The channel number fields 420₁, 420₂,420₃ in the frame fragmentation control information 415₁, 415₂, 415₃ of each frame fragment 405₁, 405₂, 405₃ are set to X to indicate that the frame fragments 405₁, 405₂, 405₃ are generated from a frame 400 designated for logical communication channel X. Moreover, the extension indicator fields 425₁, 425₂, 425₃ in the frame fragmentation control information 415₁, 415₂, 415₃ of each frame fragment 405₁, 405₂, 405₃ are set to FALSE to specify that there is no extended field.

In frame fragment 405₁, FFFI 430₁ is set to TRUE and FFSN 440₁ is set to 0, indicating that the fragment 405₁ is the first frame fragment generated from the given frame 400. Accordingly, LFFI 435₁ is set to FALSE since frame fragment 405₁ is not the last fragment generated from the given frame 400.

Furthermore, FFFI 430₂ and LFFI 435₂ fields of frame fragment 405₂ are set to FALSE since the fragment 405₂ is neither the first frame fragment nor the last frame fragment generated from the given frame 400. FFSN 440₂ is set to 1, indicating that the fragment 405₂ is the second frame fragment generated from the given frame 400.

In addition, LFFI 435₃ of frame fragment 405₃ is set to TRUE, indicating that the fragment 405₃ is the last frame fragment generated from the given frame 400. Accordingly, FFFI 430₃ is set to FALSE since frame fragment 405₃ is not the first frame fragment generated from the given frame 400. FFSN 440₃ is set to 2, specifying that the fragment 405₃ is the third frame fragment generated from the given frame 400.

As stated above, a sending unit 205 (shown in FIG. 2) generates frame segments from a given frame to generally promote transmission of frames having high priority data over frames having low priority data. FIG. 5 illustrates an example where transmission of frames having high priority data is promoted over frames having low priority data in accordance with one embodiment of the present invention. The figure shows a time line having points in time (t1, t2, t3, t4, t5, t6, t7, t8, t9, t10, and t11) when pertinent events occur.

A sending unit begins to receive frame A at time t1 and starts to transmit frame A 505 at time t2. Prior to the complete reception of frame A 505, the sending unit starts to receive frame B 510 at time t3. Frame B 510 has higher priority than Frame A 505. As a result, the sending unit promotes transmission of frame B 510 over the transmission of frame A 505. To do so, the sending unit packages the first data segment 520₁ of frame A 505 in frame fragment A1 525₁. The first data segment 520₁ of frame A 505 generally includes the portion of frame A that the sending unit receives from time t1 to time t3. The sending unit also includes frame fragmentation control information 530₁ in frame fragment A1 525₁. As previously stated, frame fragmentation control information 530₁, 530₂, 530₃, 530₄ is generally used in the process of assembling frame fragments 525₁, 525₂, 525₃, 525₄ into frames.

At time t4, the sending unit completes the transmission of frame fragment A1 525₁. The sending unit then packages frame B 510 in frame fragment B 525₂ and includes frame fragmentation control information 530₂ in frame fragment B 525₂. The sending unit begins transmission of frame fragment B 525₂ at time t5. At time t7, the sending unit completes the transmission of frame fragment B 525₂.

Prior to the completion of the transmission of frame fragment B 525₂, the sending unit begins to receive frame C 515 at time t6. Since frame B 510 and frame C 515 have similar priority (i.e., high priority), the sending unit does not promote the transmission of frame C 515 over the transmission of frame B 510. However since frame C 515 has higher priority than frame A 505, the sending unit promotes the transmission of frame C 515 over the transmission of the second data segment 520₂ of frame A 505. As such, the transmission of frame fragment C 525₃ begins after the completion of the transmission of frame fragment B 525₂ and before the start of the transmission of frame fragment A2 525₄.

The sending unit packages frame C 515 in frame fragment C 525₃ and includes frame fragmentation control information 530₃ in frame segment C 525₃. At time t8, the sending unit begins transmitting frame fragment C 525₃. The sending unit completes the transmission of frame fragment C 525₃ at time t9.

After the transmission of frame segment C 525₃ is completed, the sending unit resumes the transmission of the second data segment 520₂ of frame A 505. The sending unit packages the second data segment 520₂ of frame A 505 in frame fragment A2 525₄. The sending unit includes frame fragmentation control information 530₄ in frame fragment A2 525₄. At time t10, the sending unit begins transmitting frame fragment A2 525₄. At time till, the sending unit completes the transmission of frame fragment A2 525₄.

It should be noted that including frame fragmentation control information at the end of frame fragments enables promotion of transmission of frames having high priority data over frames having low priority data. In the midst of transmitting one frame, the sending unit may decide to suspend the transmission to promote transmission of another frame having higher priority than the current frame (i.e., the frame currently being transmitted). To suspend the transmission of the current frame, the sending unit merely needs to add frame fragmentation control information to the portion of the current frame that has already been transmitted. Afterward, the sending unit can begin transmitting the frame with high priority data. FIG. 5, as shown and described above, illustrates an example of a scenario in which transmission of a low priority frame is suspended to promote transmission of high priority frames.

FIG. 6 illustrates an order in which the receiving unit 210 (shown in FIG. 2) assembles frames 605, 610, 615 after receiving frame fragments 525₁, 525₂, 525₃, 525₄ (shown in FIG. 5) in accordance with one embodiment of the present invention. The figure shows a time line having points in time (s1, s2, s3, s4, s5, and s6) when pertinent events occur. As shown in FIG. 5, frame fragments 525₁, 525₂, 525₃, 525₄ are transmitted in the following sequential order: frame fragment A1 525₁, frame fragment B 525₂, frame fragment C 525₃, and frame fragment A2 525₄.

Returning to FIG. 6, the receiving unit reassembles the frame fragments 525₁, 525₂, 525₃, 525₄ to generate frames 605, 610, 615. The frames are generated in the following sequential order: frame B 605, frame C 610, and frame A 615. As shown in the figure, receiving unit starts generating frame B 605 at time s1 and completes generating the frame 605 at time s2. Subsequently, receiving unit begins generating frame C 610 at time s3 and finishes generating frame C 610 at time s4. Afterward, the receiving unit starts the process of assembling and generation of frame A 615 at time s5 and completes the process at time s6. Frame A 615 is assembled and generated after frames B 605 and C 610 are generated since frame fragment A2 525₄ was transmitted after the transmission of frame fragments B 525₂ and C 525₃, as shown in FIG. 5.

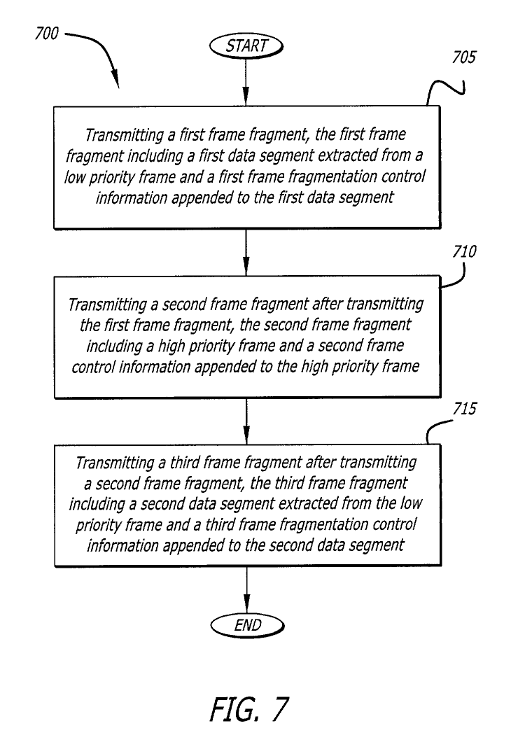

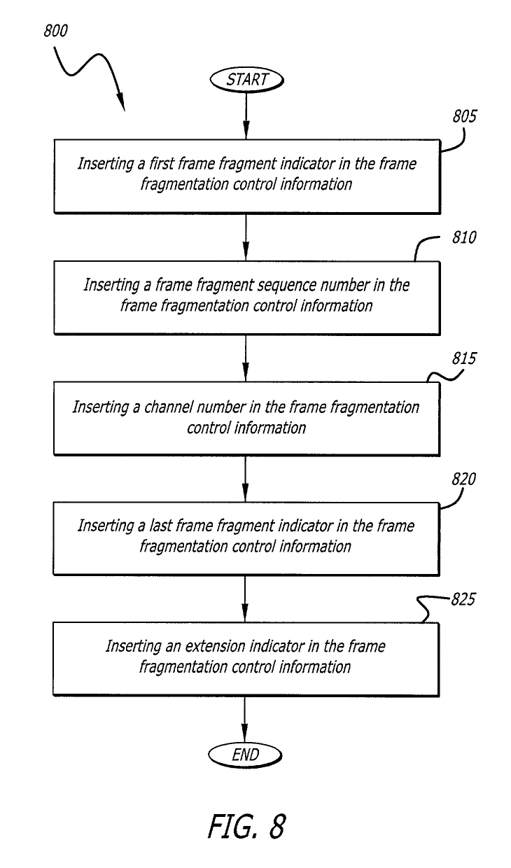

FIG. 7 generally outlines the process 700 of promoting the transmission of high priority frames over the transmission of low priority frames using the frame fragmentation technique in accordance with one embodiment of the present invention. In block 705, the first frame fragment is transmitted. The first frame fragment includes the first data segment extracted from a low priority frame and frame fragmentation control information appended to the end of the first data segment. An example of the first frame fragment is shown in FIG. 4. The process of generating frame fragmentation control information is outlined below in FIG. 8 and the description of the figure.

In block 710, a second frame fragment is transmitted. The second frame fragment includes a high priority frame. The second frame fragment further includes frame fragmentation control information appended to the end of the high priority frame. An example of the second frame fragment, including a high priority frame and frame fragmentation control information appended to the end of the high priority frame, is shown in FIG. 4. The process of generating frame fragmentation control information is outlined below in FIG. 8 and the description of the figure.

In block 715, a third frame fragment is transmitted. The third frame fragment includes the second data segment extracted from the low priority frame. The third frame fragment further includes frame fragmentation control information appended to the end of the second data segment. An example of a frame fragment, including the second data segment extracted from the low priority frame and frame fragmentation control information appended to the second data segment, is illustrated in FIG. 4. The process of generating frame fragmentation control information is outlined below in FIG. 8 and the description of the figure.

FIG. 8 generally outlines the process 800 of generating frame fragmentation control information in accordance with one embodiment of the present invention. An exemplary format of the frame fragmentation control information 310 is shown in FIG. 3. As shown in the figure, in one embodiment, frame fragmentation control information 310 can include the following fields: first frame fragment indicator 315, frame fragment sequence number 320, channel number 325, and last frame fragment indicator 330.

Returning to FIG. 8, the first frame fragment indicator is inserted in the frame fragmentation control information in block 805. As stated above, first frame fragment indicator specifies whether a frame fragment is a first fragment generated from a frame. In block 810, frame fragment sequence number is inserted in the frame fragmentation control information to generally specify a sequential order number assigned to the frame fragment.

Channel number is inserted the frame fragmentation control information in block 815. As previously stated, channel number indicates the logical communication channel to which the frame fragment is designated. Channel number is generally used to differentiate multiple payload data flows. In block 820, last frame fragment indicator is inserted in the frame fragmentation control information to specify whether the frame fragment is the last fragment generated from a frame.

The extension indicator is inserted in the frame fragment control information in block 825. As stated above, the extension indicator is generally used to extend or add fields to the frame fragment control information.

While certain exemplary embodiments have been described and shown in accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A network system, comprising:
a sending unit to transmit a first frame fragment, the first frame fragment including a first data segment extracted from a low priority frame and a first frame fragmentation control information appended to the end of the first data segment; and
a receiving unit to receive the first frame fragment transmitted by the sending unit.

2. The system of claim 1, wherein:
the sending unit to transmit a second frame fragment, the second frame fragment including a high priority frame and a second frame fragmentation control information appended to the end of the high priority frame; and
the receiving unit to receive the second frame fragment transmitted by the sending unit.

3. The system of claim 1, wherein:
the sending unit to transmit a third frame fragment, the third frame fragment including a second data segment extracted from the low priority frame and a third frame fragmentation control information appended to the end of the second data segment; and
the receiving unit to receive the third frame fragment transmitted by the sending unit.

4. The system of claim 3, wherein each of the first frame fragmentation control information, the second fragmentation control information, and the third fragmentation control information includes a first frame fragmentation indicator.

5. The system of claim 3, wherein each of the first frame fragmentation control information, the second fragmentation control information, and the third fragmentation control information includes a frame fragment sequence number.

6. The system of claim 3, wherein each of the first frame fragmentation control information, the second fragmentation control information, and the third fragmentation control information includes a channel number.

7. The system of claim 3, wherein each of the first frame fragmentation control information, the second fragmentation control information, and the third fragmentation control information includes a last frame fragment indicator.

8. The system of claim 3, wherein each of the first frame fragmentation control information, the second fragmentation control information, and the third fragmentation control information includes an extension indicator.

9. A sending unit, comprising:
a frame fragment generator to generate frame fragments from frames, each of the frame fragments including a payload data and a frame fragmentation control information appended to the end of the payload data to enable the frame fragments to be reassembled into frames; and
a data transmitter to transmit the frame fragments generated by the frame fragment generator.

10. The sending unit of claim 9, wherein the payload data includes an entire frame.

11. The sending unit of claim 9, wherein the payload data includes a data segment extracted from a frame.

12. The sending unit of claim 9, wherein the frame fragmentation control information includes a first frame fragment indicator to specify whether a frame fragment is a first fragment generated from a frame.

13. The sending unit of claim 9, wherein the frame fragmentation control information includes a frame fragment sequence number to specify a sequential order number assigned to each frame fragment generated from a frame.

14. The sending unit of claim 9, wherein the frame fragmentation control information includes a channel number to indicate the logical communication channel to which a frame fragment is designated.

15. The sending unit of claim 9, wherein the frame fragmentation control information includes a last frame fragment indicator to specify whether a frame is a last fragment generated from a frame.

16. The sending unit of claim 9, wherein the frame fragmentation control information includes an extension indicator used to add fields to the frame fragmentation control information.

16. A machine-readable medium comprising instructions which, when executed by a machine, cause the machine to perform operations comprising:
a first code segment to generate frame fragments from frames, each of the frame fragments including a payload data and a frame fragmentation control information appended to the end of the payload data to enable the frame fragments to be reassembled into frames; and
a second code segment to transmit the frame fragments generated by the frame fragment generator.

17. The machine-readable medium of claim 16, wherein the frame fragmentation control information includes:
a first frame fragment indicator to specify whether a frame fragment is a first fragment generated from a frame; and
a last frame fragment indicator to specify whether the frame fragment is a last fragment generated from the frame.

18. The machine-readable medium of claim 16, wherein the frame fragmentation control information includes a frame fragment sequence number to specify a sequential order number assigned to each frame fragment generated from a frame.

19. The machine-readable medium of claim 16, wherein the frame fragmentation control information includes a channel number to indicate the logical communication channel to which a frame fragment is designated.

20. The machine-readable medium of claim 16, wherein the frame fragmentation control information includes an extension indicator used to add fields to the frame fragmentation control information.

21. A method, comprising:
transmitting a first frame fragment including a first data segment extracted from a low priority frame and a first frame fragmentation control information appended to the end of the first data segment;
transmitting a second frame fragment after transmitting the first frame fragment, the second frame fragment including a high priority frame; and
transmitting a third frame fragment after transmitting the second frame fragment, the third frame fragment including a second data segment extracted from the low priority frame.

22. The method of claim 21, wherein transmitting the second frame fragment includes appending a second frame fragmentation control information to the end of the high priority frame.

23. The method of claim 22, wherein transmitting the third frame fragment includes appending a third frame fragmentation control information to the end of the second data segment extracted from the low priority frame.

24. The method of claim 23, further includes inserting a first frame fragmentation indicator in each of the first fragmentation control information, the second fragmentation control information, and the third fragmentation control information.

25. The method of claim 23, further includes inserting a frame fragment sequence number in each of the first fragmentation control information, the second fragmentation control information, and the third fragmentation control information.

26. The method of claim 23, further includes inserting a channel number in each of the first fragmentation control information, the second fragmentation control information, and the third fragmentation control information.

27. The method of claim 23, further includes inserting a last frame fragment indicator in each of the first fragmentation control information, the second fragmentation control information, and the third fragmentation control information.

28. The method of claim 23, further includes inserting an extension indicator in each of the first fragmentation control information, the second fragmentation control information, and the third fragmentation control information.
